(19) United States
(12) Patent Application Publication
(10) Pub. No.: US 2023/0278861 A1
(43) Pub. Date: Sep. 7, 2023

(54) METHOD, COMPOSITION AND SYSTEM FOR GENERATING AN OXYGEN-FLOW

(71) Applicant: DACELO B.V., Aerdenhout (NL)

(72) Inventors: Leonard Peter VAN DER ZWAN, Aerdenhout (NL); Jozef Cornelis GROEN, Aerdenhout (NL); Robert IJsbrand Charles Domingo EIJSVOGEL, Aerdenhout (NL)

(73) Assignee: DACELO B.V., Aerdenhout (NL)

(21) Appl. No.: 17/998,196

(22) PCT Filed: May 6, 2021
(86) PCT No.: PCT/NL2021/050294

§ 371 Date: Nov. 8, 2022

(30) Foreign Application Priority Data
May 8, 2020 (NL) 2025537

(51) Int. Cl. C01B 13/02; C10L 5/12; C10L 5/36

(52) U.S. Cl. CPC C01B 13/0218; C01B 13/0296; C10L 5/12; C10L 5/363; C01P 2004/51; C01P 2004/61; C10L 2200/0254

(57) ABSTRACT

The invention provides a solid material for generating a flow of oxygen, the solid material comprising a chemical mixture for generating said flow of oxygen, the chemical mixture comprising as chemical components:
1-25% w/w of a self-sustaining decomposition additive, wherein the decomposition additive is selected from the group of copper (Cu), aluminium (Al), magnesium (Mg), zinc (Zn), molybdenum (Mo), manganese (Mn), cobalt (Co), nickel (Ni), iron (Fe), cobalt oxides (Co₂O₃ and Co₃O₄), copper oxide (CuO), iron oxide (Fe₂O₃), zinc oxide (ZnO), manganese oide (MnO), manganese dioxide (MnO₂), chrome (Cr), chrome oxides, titanium, titanium oxides, and combinations thereof;
65-97% w/w of an oxygen generating component, wherein the oxygen generating component is selected from the group of alkali chlorates and alkali perchlorates, and alkali superoxides;
2-5% w/w of an inorganic binder;
wherein said weight percentages are based upon the weight of the total solid material, wherein said solid material has a skeletal density of 2.8-3.5 g/cm³,
wherein said solid material has a porosity of 30-50%, and wherein in said chemical mixture components are provided as particles having a volume particle size distribution having its peak between 5 and 100 μm.

### FIELD OF THE INVENTION

The invention relates to a solid material for generating a flow of oxygen, a fuel tablet and candle, a method for producing oxygen, a method for producing a fuel tablet for use in an oxygen-producing system, and a kit-of-parts comprising the solid material.

### BACKGROUND OF THE INVENTION

WO2003009899 according to its abstract is directed to a chemical oxygen generator to produce cool oxygen gas comprising: a. a charge housing, b. a solid but porous charge contained in the said housing, the charge being made of a chemical mixture that generates oxygen upon decomposition and that will undergo a self-sustained exothermal decomposition after initiation, the said charge containing at most 3.0 wt. % of binder material, the said porous charge allows the generated oxygen to pass through the charge without damaging the virgin material and without creating volumetric burning, the said charge is mounted in the housing in such a way that the generated oxygen passes through the charge and under the pressure difference flows from the moving decomposition front towards the vent, c. an ignition device mounted at one end of the cartridge in such a way that it is capable to initiate a self-sustained decomposition of the charge at the charge surface adjacent to the initiator, d. one or more vents mounted in such a way that the generated oxygen that has passed through the generating porous charge leave the gas generator through the said vents.

U.S. Pat. No. 6,030,583 according to its abstract is directed to oxygen generating compositions contain carbon-free metal powder as fuel to minimize generation of carbon monoxide. The carbon-free metal powder can be selected from copper, zinc, and antimony, and mixtures thereof, and can be used in combination with tin or iron. The oxygen generating compositions produce a breathable gas upon ignition of the composition, and comprise about 1-15% by dry weight of the metal powder as a fuel; about 0.1-5% by dry weight of at least one alkaline compound; a transition metal oxide catalyst; and the remainder substantially comprising an oxygen source. The oxygen generating compositions can optionally include a binder. An oxygen generating candle can also have an ignition pellet having a composition of about 25-50% by weight copper, zinc or antimony, 5-20% by weight Co₃O₄, about 2-5% by weight glass powder, 0-25% by weight KClO₄, and the balance being substantially NaClO₃.

U.S. Pat. No. 6,193,907 according to its abstract is directed to “chlorate/perchlorate based oxygen generating compositions contain about 0.5-15% by weight of metal powder for use as a fuel selected from the group consisting of iron, nickel, cobalt and mixtures thereof; about 0.1% to about 15% by weight of at least one transition metal oxide catalyst; greater than 5% to about 25% by weight of an alkali metal silicate as a reaction rate and core rheology modifier, binder and chlorine suppresser; and the remainder substantially comprising an oxygen source selected from the group consisting of alkali metal chlorates, alkali metal perchlorates, and mixtures thereof. The alkali metal silicate can be selected from the group consisting of sodium metasilicate, sodium orthosilicate, lithium metasilicate, potassium silicate, and mixtures thereof. The oxygen generating composition can also optionally contain a binder selected from the group consisting of glass powder, fiber glass and mixtures thereof.”

WO2019/128370 according to its abstract is directed to “An oxygen-generating candle, comprising an absorption flammable layer, a heat generating layer and a main candle body layer; the heat generating layer is provided between the absorption flammable layer and the main body layer; according to mass percentage, the main body layer is made of 90% to 96% chlorate, 1.5% to 5% catalyst, 0 to 3% fuel, 1.5% to 2.5% binder and 0.5% to 1.5% stabilizer; the heat generating layer is made of 70% to 80% chlorate, 5% to 15% catalyst, 5% to 12% fuel and 3.0% to 6.0% binder; the absorption flammable layer is made of 5% to 15% fuel, 80% to 90% strontium chromate, 3% to 5% binder and 0 to 1% chlorate; the catalyst is a combination of two or more from among cobalt oxide, manganese dioxide and titanium oxide; the amount of catalyst in the main candle body layer is 4-5 times greater than the amount of the catalyst of the heating layer; the fuel comprises one or more from among magnesium powder, titanium powder, cobalt powder, and zirconium powder.”

U.S. Pat. No. 5,298,187 according to its abstract is directed to “An oxygen-generating candle composition is disclosed of the type that includes an amount of an alkali metal chlorate or perchlorate oxygen source and which upon initiation and decomposition yields oxygen and residual chlorine, wherein the improvement comprises a non-toxic additive in the candle composition for suppression of the residual chlorine and to enhance uniform oxygen generation and evolution. The additive is selected from the group consisting of from about 0.05% to about 10% by weight of lithium aluminate, metaborate, tetraborate, phosphate or pyrophosphate, metasilicate or orthsilicate, or carbonate, calcium phosphate or pyrophosphate, strontium carbonate or phosphate, or sodium metasilicate or orthosilicate. A metal oxide catalyst, a metal powder fuel, and a binder or filler are also included in the composition.

### SUMMARY OF THE INVENTION

A disadvantage of the prior art is, amongst others, a relatively low varying oxygen flow with limited predictability.

Hence, it is an aspect of the invention to provide an alternative, which preferably further at least partly obviates one or more of above-described drawbacks.

There is provided a solid material for generating a flow of oxygen comprising a chemical mixture for generating said flow of oxygen comprising as chemical components:
1-25% w/w of a self-sustaining decomposition additive, selected from the group of copper (Cu), aluminium (Al), magnesium (Mg), zinc (Zn), molybdenum (Mo), manganese (Mn), cobalt (Co), nickel (Ni), iron (Fe), cobalt oxides (Co₂O₃ and Co₃O₄), copper oxide (CuO), iron oxide (Fe₂O₃), zinc oxide (ZnO), manganese oxide (MnO), manganese dioxide (MnO₂), MnₓO_{y}, chrome (Cr), chrome oxides, titanium, titanium oxides, and mixtures thereof;
65-97% w/w of an oxygen generating component, selected from the group of alkali chlorates and perchlorates, specifically lithium perchlorate (LiClO₄), lithium chlorate (LiClO₃), sodium perchlorate (NaClO₄), sodium chlorate (NaClO₃), potassium perchlorate (KClO₄) and potassium chlorate (KClO₃), more preferably sodium chlorate (NaClO₃), from the group of alkali peroxides and superoxides, preferably sodium peroxide (Na₂O₂), potassium peroxide (K₂O₂), sodium superoxide (NaO₂) and potassium superoxide (KO₂), and mixtures thereof;
2-5% w/w of an inorganic binder, in particular selected from Na₂SiO₃, K₂SiO₃, and mixtures thereof;
wherein said weight percentages are based upon the weight of the total solid material, wherein said solid material has a skeletal density of 2.8-3.5 g/cm³, wherein said solid material has a porosity of 30-50%, and
wherein said chemical components are provided as particles having a volume particle size distribution having its peak between 5 and 100 μm.

In an embodiment, both the skeletal density and the porosity are measured and/or determined using a helium pycnometer.

In an embodiment, the chemical solid material comprises as components 7-22% w/w of the self-sustaining decomposition additive, more preferably 10-20% w/w, such as 15-18% w/w.

In an embodiment, the self-sustaining decomposition additive is selected from the group of copper (Cu), aluminium (Al), magnesium (Mg), zinc (Zn), molybdenum (Mo), manganese (Mn), cobalt (Co), nickel (Ni), iron (Fe), cobalt oxides (Co₂O₃ and Co₃O₄), copper oxide (CuO), iron oxide (Fe₂O₃), zinc oxide (ZnO), manganese oxide (MnO), manganese dioxide (MnO₂), and mixtures thereof. Preferentially, selected from the group of copper (Cu), aluminium (Al), iron (Fe), copper oxide (CuO), iron oxide (Fe₂O₃), manganese oxide (MnO), manganese dioxide (MnO₂), MnₓO_{y} and mixtures thereof.

MnₓO_{y} in particular and preferably refers to the following are manganese oxide variations:
Manganese(II) oxide, MnO
Manganese(II,III) oxide, Mn₃O₄
Manganese(III) oxide, Mn₂O₃
Manganese dioxide, (manganese(IV) oxide), MnO₂
Manganese(VI) oxide, MnO₃
Manganese(VII) oxide, Mn₂O₇
Other manganese oxides include Mn₅O₈.

It was found that some of these self-sustaining decomposition additives accelerate the reaction. In an embodiment, a mixture of these self-sustaining decomposition additives comprises copper (Cu) and manganese dioxide (MnO₂). A more fierce reaction results form for instance iron (Fe) and manganese dioxide (MnO₂). In an embodiment, Iron and Copper may be mixed to set a reaction rate.

In an embodiment, the chemical mixture comprises 76-88% w/w of the oxygen generating component, more preferably 78-86% w/w, such as 80-83% w/w.

In an embodiment, the oxygen generating component is selected from the group of alkali chlorates and perchlorates, from the group of alkali peroxides and alkali superoxides, and mixtures thereof.

In an embodiment, the alkali chlorates and perchlorates are selected from the group of lithium perchlorate (LiClO₄), lithium chlorate (LiClO₃), sodium perchlorate (NaClO₄), sodium chlorate (NaClO₃), potassium perchlorate (KClO₄), potassium chlorate (KClO₃), and mixtures thereof.

In an embodiment, the oxygen generating component is selected from sodium chlorate (NaClO₃). It was found using mainly this compound provided a controllable temperature during reaction.

In an embodiment, using permanganates and mixtures thereof. That these components provide a more fierce reaction, and can be added in combination with the mentioned chlorates and perchlorates for instance in a starter tablet. For instance, spots can be provided near an igniter to more easily start ignition of a candle of tablets. In particular, for instance kalium permanganate. Some of these oxygen generating components can be mixed to increase or decrease reaction speed and heat generation. A starter tablet, for instance, may locally comprise of more of a fiercely reacting compound to start up the reaction more easily.

In an embodiment, the binder amount is 2.2-4.5% w/w, more preferably 2.5-4.0% w/w, such as 2.7-3.5% w/w.

In an embodiment, the binder is an inorganic binder, selected from clay or one or more silicates. In an embodiment, the binder is selected from Na₂SiO₃, K₂SiO₃, and mixtures thereof.

In an embodiment, the solid material has a skeletal density of 2.8-3.5 g/cm³, preferably 2.85-3.3 g/cm³, more preferably 2.9-3.25 g/cm³, In an embodiment, said solid material has a porosity of 31-40%, even more preferably a porosity of 33-38%.

In an embodiment, the chemical components are provided as particles having a volume particle size distribution having its peak between 20 and 100 μm. Preferably the particles have at least 60% of a combined volume particle size distribution having its peak between 30-80 μm In an embodiment, particle size is measured using laser forward light scattering. This may also be referred to as ‘laser diffraction’ particle size measurement. Alternative methods are for instance using sieves. In the description of embodiments, measurements are explained.

In an embodiment, the shape of the volume particle size distribution will substantially be in inverse Gauss distribution.

Measurement of the porosity is explained below.

In an embodiment, the volume particle size distribution has a lower full width at half maximum of less than 20 μm at the lower particle size range and a higher full width at half maximum of less than 50 μm at the higher particle size range.

In an embodiment, the volume particle size distribution has substantially no particles smaller than the self-sustaining decomposition additive, such as manganese dioxide particles, and substantially no particles larger than the oxygen generating component.

In an embodiment, a gas mixture is produced, the gas mixture comprising of less than 100 ppm of chlorine (Cl₂), preferably less than 10 ppm, more preferably less than 5 ppm.

In an embodiment, the gas mixture comprises less than 10 ppm carbon (C), preferably less than 5 ppm. In an embodiment, said solid material has a water content of below 1% by weight, preferably below 0.5% by weight, more preferably below 0.2% by weight.

In an embodiment, the chemical components comprise:
as self-sustaining decomposition additive 5-16% w/w Cu and 2-4% w/w MnO₂,
as oxygen generating component 75-90% w/w NaClO₃, and
as inorganic binder 2-5% w/w Na₂SiO₃.

In an embodiment, the chemical components comprise:
as self-sustaining decomposition additive 10-15% w/w Cu and 2-4% w/w MnO₂,
as oxygen generating component 78-80% w/w NaClO₃; and
as inorganic binder 2-5% w/w Na₂SiO₃.

In an embodiment, the solid material has a mixing homogeneity for Cu better than 20% from a theoretical value and for chloride to differ less than 10% from a theoretical value.

In an embodiment, the components are intimately mixed and preferably pressed into at least one fuel tablet. There is further provided a fuel tablet.

In an embodiment, such a fuel tablet has a flow directional cross section area of 10-40 cm².

Preferentially, with a flow directional cross sectional area of 15-35 cm².

In an embodiment, a fuel tablet has a height of 0.5-5 cm. Preferentially, with a height of 1-3 cm.

There is further provided a candle for producing a flow of oxygen and comprising of the described solid material, with at least one tablet as described. Such a candle can have a height of 10-30 cm.

In an embodiment, the candle comprises of a starting part, in particular a start tablet. Such a start tablet in an embodiment has a composition comprising of:
25-45% w/w self-sustaining decomposition additive, such as selected from Cu, Fe or a mixture thereof, in particular 30-40% w/w, preferably 34-37% w/w;
78-88% w/w oxygen generating component, such as NaClO₃, in particular 78-80% w/w NaClO₃;
2-5% w/w inorganic binder, such as Na₂SiO₃;
2-4% w/w self-sustaining decomposition additive, such as MnO₂.

Preferably the start tablet part is provided at an end of one or more stacked tablets.

In an embodiment, such a starter tablet comprises amounts of the more fiercely reacting components mentioned above. For instance, Co, Fe, Al or their oxides as catalyst or fuel to generate heat or potassium permanganate.

There is further provided a method for producing a flow of gas comprising of oxygen with more than 99% purity, preferably more than 99.4% purity, more preferably more than 99.7% purity. In an embodiment, such a flow of gas has less than 100 ppm of Cl₂ and CO, more in particular less than 10 ppm, more preferably less than 5 ppm. Such a method comprises of providing a solid material as described, a fuel tablet described, or a candle as described. The method comprises increasing the temperature of the solid material to above 450° C., and producing oxygen.

In an embodiment, the solid material is composed to result in a gas flow comprising of more than 99% O₂ by volume at a flow rate of more than 0.4 L/min/cm² of said solid material. In particular the flow rate is more than 0.45 L/min/cm². More in particular, the flow rate is more than 0.46 L/min/cm² of solid material.

In an embodiment for producing a flow of oxygen of at least 6 L/min for at least 60 seconds and a mass loss of better than 10% from theoretical mass loss, said solid material is provided with a flow directional cross sectional area of 12.6 cm². In fact, flow directional cross section is to be understood as a cross section having the flow direction as a normal direction. For a right circle cylinder, this is the area of an end.

In an embodiment, the solid material is provided in a height of 2-30 cm. preferably with a height of 5-12 cm.

In an embodiment, a start tablet is provided and having a composition comprising of:
10-45% w/w self-sustaining decomposition additive, such as Cu or Fe, in particular 30-40% w/w Cu;
65-85% w/w oxygen generating component, such as NaClO₃, in particular 78-80% w/w NaClO₃;
2-5% w/w inorganic binder, such as Na₂SiO₃;
2-4% w/w self-sustaining decomposition additive, such as MnO₂; and preferably a water content below 0.15 wt %.

In an embodiment, the start tablet is produced from said chemical components as powders having a combined volume particle size distribution of mixture average of between 20 and 50 μm and a full width at half maximum (FWHM) of less than 20 μm at the lower particle seize range and 50 μm at the higher particle size range and measured using laser scattering, said powders mixed and pressed into said at least one tablet, and with substantially no particles smaller than the manganese dioxide powder particles and substantially no particles larger than the sodium metasilicate powder particles.

There is further provided a method for producing a fuel tablet for use in an oxygen-producing system, said chemical component comprising of:
5-25% w/w of a self-sustaining decomposition additive,
75-90% w/w of an oxygen generating component,
2-5% w/w of an inorganic binder,

from said chemical components as powders having a combined volume particle size distribution of solid material average of between 20 and 50 μm and a FWHM of 9 μm lower and 100 measured using laser scattering;
producing granules from said solid material, said granules having a particle size of 1-4 mm sieve fraction and between 2 and 7% w/w water, preferably between 3 and 6 weight %;
pressing a tablet from said granules, and
drying said tablet to a water content of below 1% w/w based upon total weight, preferably below 0.5% w/w, more preferably below 0.2% w/w.

In an embodiment of this method substantially no particle is smaller than MnO₂ particles and substantially no particle is larger than Na₂SiO₃ particles.

In an embodiment, the volume particle size distribution of said solid material of powders has an average of between 20 and 50 μm and has a FWHM less than 20 μm at the lower particle size and less than 40 μm at the higher particle size when measured using laser scattering.

In an embodiment, in the start tablet said granules having a particle size of 2 mm sieve fraction.

In an embodiment of the method, the start tablet is pressed at pressure of between 1.5 and 10 bar, in particular around 1.7 bar.

In an embodiment of the method, a candle comprises at least 3 fuel tablets and one start tablet. A candle can comprise one single, solid cylinder of solid material for producing a flow of oxygen. In an embodiment, a candle comprises stacked tablets that form a (right circle) cylinder. Often, such a candle comprises a start tablet at one end.

In an embodiment, a candle is provided comprising an ignition device providing 400-950° C., in part 450-950° C. to said start tablet.

There is further provided a kit-of-parts comprising at least one of a solid material described above, a tablet of a solid material described above, a candle described above, and a start tablet described above. In particular, a kit of parts comprises a series of fuel tablets and a start tablet.

The terms “upstream” and “downstream” relate to an arrangement of items or features relative to the propagation of the gas flow from, wherein “upstream” is relative to a start and “downstream” is at the outlet of the gas.

The term “substantially” herein, such as in “substantially consists”, will be understood by the person skilled in the art. The term “substantially” may also include embodiments with “entirely”, “completely”, “all”, etc. Hence, in embodiments the adjective substantially may also be removed. Where applicable, the term “substantially” may also relate to 90% or higher, such as 95% or higher, especially 99% or higher, even more especially 99.5% or higher, including 100%. The term “comprise” includes also embodiments wherein the term “comprises” means “consists of”.

The term “functionally” will be understood by, and be clear to, a person skilled in the art. The term “substantially” as well as “functionally” may also include embodiments with “entirely”, “completely”, “all”, etc. Hence, in embodiments the adjective functionally may also be removed. When used, for instance in “functionally parallel”, a skilled person will understand that the adjective “functionally” includes the term substantially as explained above. Functionally in particular is to be understood to include a configuration of features that allows these features to function as if the adjective “functionally” was not present. The term “functionally” is intended to cover variations in the feature to which it refers, and which variations are such that in the functional use of the feature, possibly in combination with other features it relates to in the invention, that combination of features is able to operate or function. The word “functionally” as for instance used in “functionally parallel” is used to cover exactly parallel, but also the embodiments that are covered by the word “substantially” explained above. For instance, “functionally parallel” relates to embodiments that in operation function as if the parts are for instance parallel. This covers embodiments for which it is clear to a skilled person that it operates within its intended field of use as if it were parallel.

Furthermore, the terms first, second, third and the like in the description and in the claims, are used for distinguishing between similar elements and not necessarily for describing a sequential or chronological order. It is to be understood that the terms so used are interchangeable under appropriate circumstances and that the embodiments of the invention described herein are capable of operation in other sequences than described or illustrated herein.

It should be noted that the above-mentioned embodiments illustrate rather than limit the invention, and that those skilled in the art will be able to design many alternative embodiments without departing from the scope of the appended claims. In the claims, any reference signs placed between parentheses shall not be construed as limiting the claim. Use of the verb “to comprise” and its conjugations does not exclude the presence of elements or steps other than those stated in a claim. The article “a” or “an” preceding an element does not exclude the presence of a plurality of such elements. The mere fact that certain measures are recited in mutually different dependent claims does not indicate that a combination of these measures cannot be used to advantage.

The invention further applies to an apparatus or device comprising one or more of the characterising features described in the description and/or shown in the attached drawings. The invention further pertains to a method or process comprising one or more of the characterising features described in the description and/or shown in the attached drawings.

The various aspects discussed in this patent can be combined in order to provide additional advantages. Furthermore, some of the features can form the basis for one or more divisional applications.

### BRIEF DESCRIPTION OF THE DRAWINGS

Embodiments of the invention will now be described, by way of example only, with reference to the accompanying schematic drawings in which corresponding reference symbols indicate corresponding parts, and which shows:

FIG. 1: A volume particle size distribution of chemical components before treatment;

FIG. 2: A volume particle size distribution of chemical components after grinding;

FIG. 3: A bar graph tablet of porosity for wet and dry compression;

FIG. 4: A skeletal density of different parts of milled chemical components;

FIG. 5: Elemental homogeneity as illustrated by a bar graph;

FIG. 6: Elemental homogeneity as illustrated by a line graph;

FIG. 7: Tablet porosity as a result of pressing time, at 323 bar applied pressure;

FIG. 8: Tablet porosity as a function of granule size fraction;

FIG. 9: Mean crushing strength of granules versus applied pressure;

FIG. 10: Tablet porosity as a result of drying time with 3.75 bars pressing for two minutes, including pictures of the resulting tablets;

FIG. 11: Tablet porosity as a result of drying time at indicated pressure;

FIG. 12: Mercury intrusion and extrusion curves;

FIG. 13: Differential pore size distribution for various pre-processing conditions;

FIG. 14: Chromatogram of produced gasses;

FIG. 15: Schematic diagram of an oxygen-producing device with tablets;

FIG. 16: Temperature profile over time during candle burning;

FIG. 17: Chromatogram and spectrum of resulting gas during candle burning;

FIG. 18: Flow rate of gas during candle burning for a candle diameter of 31 mm;

FIG. 19: 12-tablet combustion trial with 4.25% iron (Fe);

FIG. 20: Temperature profile over time during a 12 tablet burning;

FIG. 21: Comparison between the combustion of Al and Mo;

FIG. 22: Comparison between the combustion of Fe and Mo, and

FIG. 23: Ignition time dependency on granule size;

The drawings are not necessarily on scale.

### DESCRIPTION OF PREFERRED EMBODIMENTS

Various parameters have been tested in the examples below.

### Example I—Powder Treatment: Milling and Mixing

It was found that in order to ensure a uniformly dry powder mixture for the candle filling, the powder particles of the various components must be small. In this respect, a particle size reduction process step is often needed to obtain the numbers according to for instance the claims. The components preferably have substantially the same size (distribution). If the particle size or the skeletal density of the various components is very different, segregation was found to occur. This means that during mixing, and subsequent steps/unit operations, the mixture can easily de-mix, leading to an impaired or non-functioning product.

The following chemicals were used for preparation of the candle filler material:
Sodium chlorate (NaClO₃)
Copper (Cu)
Manganese (IV) oxide (MnO₂)
Sodium metasilicate (Na₂SiO₃)
Demineralized water (for granulation)

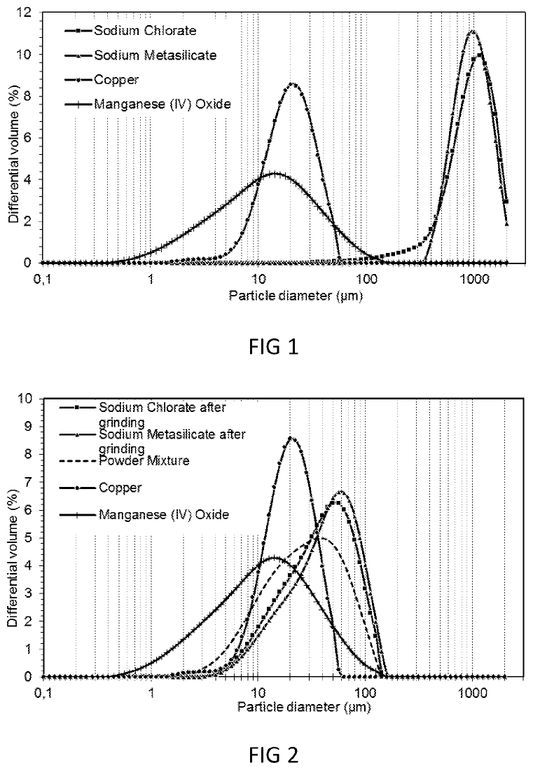

The volume particle size distributions of the raw materials were measured before and after grinding by means of laser scattering on a Malvern Mastersizer 2000 using a dry dispersion method. In FIG. 1, an example of a volume particle size distribution before milling is shown. FIG. 2 shows the volume particle size distribution after treatment, including in this example milling.

The chemical mixture have different particle sizes and especially the sodium chlorate and the sodium metasilicate have substantially larger particles. In order to make the various components more similar in particle size, the sodium chlorate and sodium metasilicate had to be milled and they were milled separately using a Profi Cook KSW 1021 coffee grinder for 1 minute. After grinding, the powdered sodium chlorate and sodium metasilicate were each sieved using sieve MESH 75 μm in order to select the smaller than 75 μm fraction. The particles that comes through the sieve were collected in a glass bottle and particles that remained on the sieve were put back into the grinder.

It can be observed that the particle size of the sodium metasilicate and the sodium chlorate with a mode at approx. 1000 μm is indeed substantially larger than that of the copper and manganese oxide of which the volume particle size distribution is overall <100 μm. After milling the sodium metasilicate and the sodium chlorate, the volume particle size distributions of all materials clearly are more alike. The sodium chlorate and metasilicate particles clearly have become smaller after grinding and their distributions have shifted to the left and overlap with the other chemicals. This should be highly beneficial in the mixing process.

For a solid material of in total 100 g, all four chemicals were weighed according to the following ratio; 79 g of NaClO₃, 14 g of Cu, 3 g of MnO₂, and 4 g of Na₂SiO₃.

The chemicals were also mixed in the Profi Cook KSW 1021 coffee grinder for a duration of 1 minute. After mixing, a uniformly-coloured powder mixture was obtained suggesting that—at least with the naked eye—the powder was effectively mixed.

The black coloured curve, in FIG. 2, shows the volume particle size distribution of the powder mixture. The powder mixture has no particles smaller than the manganese dioxide and no particles larger than the sodium metasilicate.

Next, a homogeneity of the solid material was examined.

The solid material prepared above was sampled using a funnel, since sampling of powders should preferably be done in motion. This sampling was executed by pouring the content of the blender through a powder funnel and with help of a piece of cardboard, the solid material was divided into three fractions: top, middle, and bottom.

Each fraction was then divided into representative sub-lots using a Quantachrome micro spinning riffler to obtain sub-lots of preferably 1.5-2 g in size.

Some of the sub-divided small samples of 2 g each were pressed into a tablet using a 13 mm pellet die at 9-10 tonnes for 10 minutes. This tablet preparation was used to provide a smooth surface (improved accuracy of the analysis) and for homogenization for the subsequent chemical assay elemental analysis.

The tablets were then dried in a vacuum oven at 25° C. for 15 minutes. For each fraction, two samples were pressed into two tablets.

The tablets were then analysed by a Hitachi™ 3030 SEM-EDX to determine the mixing quality.

Two to three different spots were measured for each tablet.

In order to verify whether the SEM-EDX can measure all elements accurately and correctly, the theoretical expected concentration should be calculated and also reference samples were prepared.

Firstly, the theoretical percentages composition by mass of each element and from each compound can be calculated, using the following equation:

% by mass of Z=100×Ar(Z)×(atoms of Z)/Mr(compound)

(Where Z is the element, Ar is the relative atomic mass and Mr is the relative formula mass) The theoretical weight percentages are the ideal values that the powder mixture has. In practice, mostly the ideal or the perfect values are impossible to achieve. This is due to the systematic error in the SEM-EDX analysis and can be caused by experimental or sampling errors. Therefore, the reference powder mixtures are made to be the benchmark of the analysis.

Reference mixture A was made from a total of 2 g powder mixture, the powder was mixed with a spoon and pressed into a tablet. 2 g is the appropriate sample size to be made directly into a tablet to be analysed using SEM-EDX. Since 2 g is rather little amount, no sampling is required and it is not possible to use the grinder to mix it. A new reference mixture B later was made using a total of 48 g powder mixture, mixed in the coffee grinder, but the mixture was not sampled.

The assay analysis of reference mixture A and B is presented in the table below, along with the calculated theoretical weight percentages. SEM-EDX spot measurements.

| | Theoretical | Reference Mixture A | | Reference Mixture B | |
|---|---|---|---|---|---|
| Element | wt % | wt % | % deviations | wt % | % deviations |
| O | 38.19 | 33 | −14 | 37 | −4 |
| Na | 18.57 | 23 | 21 | 22 | 21 |
| Cl | 26.35 | 21 | −20 | 24 | −8 |
| Cu | 13.69 | 19 | 40 | 10 | −25 |

Note that it is difficult to get reliable measurements for light elements (atomic number below 11) using EDX because they produce weaker signal compared to heavy elements and longer wavelength X-rays which is readily absorbable within the sample (Australian Microscopy & Microanalysis Research Facility, 2014). Oxygen is a light element, which means that its measurements will contain larger errors, unlike the other elements. The measured concentration of the oxygen can be further affected with the water content of the sample. Sodium chlorate and sodium metasilicate are hygroscopic. It is possible that some moisture that the chemicals picked up during the process remained in the sample, although the sample was pre-treated in a vacuum oven.

The data in the table shows that reference mixture A has higher percent deviations from the theoretical values compared to reference mixture B. Negative deviation signifies that the measured weight percent is lower than the theoretical one. The high deviations for reference mixture A are caused by insufficient and poor manual mixing of the powders. The mixing process in the coffee grinder is assumed to be adequate. Mixture B clearly shows assay results that are closer to the theoretical values. However, some elements still have notable deviations. The measured manganese has doubled its amount in both mixtures. In reference mixture B, the copper and silicon are present 25% and 15% less, respectively. This is possibly due to the absorption correction of the X-rays between the elements. X-rays are absorbed within the sample or pass through the sample. The probability of the absorption of the X-rays depends on the elements in the sample and their ionization energies. Besides that, the distance that the X-ray travels through the sample before it escapes and enters the detector can lead to absorption. The mass absorption coefficient of Cu by Mn is 272.4 and Mn by Cu is 123.8 (Australian Microscopy & Microanalysis Research Facility, 2014). This means that the Cu X-ray can be absorbed by Mn, resulting in higher Mn and lower Cu X-rays intensities. This corresponds to the data, measured Mn is always higher than the theoretical value while the measured Cu is lower only in reference mixture B.

Reference mixture A was mixed poorly that might affect higher percentages of Cu and Si. Although Cu already has a similar particle size to the other chemicals, it has a high skeletal density which can lead to segregation and it is more difficult to blend. Reference mixture A suffers more segregation while tableting. Hence, reference mixture B is more reliable and will be used as the benchmark for this analysis, also including potential systematic errors by the SEM-EDX technique.

Next, a sample was prepared and divides into three fractions, a top, middle and bottom fraction.

Measurements using helium pycnometer showed a skeletal density of 2.822±0.004 g/cm³, 2.829±0.004 g/cm³ and 2.814±0.004 g/cm³. Thus, all the samples are within 2 sigma identical. Next, the homogeneity was measured using SEM-EDX measurement. Results can be found in the table below.

| | | | | | Deviation (abs wt %) | | |
|---|---|---|---|---|---|---|---|
| | Average wt % | | | | | Middle | |
| | Benchmark | | | | Top & | & | Top & |
| | wt % | Top | Middle | Bottom | middle | bottom | bottom |
| O | 37 | 36 | 38 | 38 | −2 | 0.5 | −1.7 |
| Na | 24 | 24 | 26 | 26 | −2 | −0.1 | −2.2 |
| Cl | 22 | 23 | 20 | 20 | 2.5 | 0.1 | 2.6 |
| Cu | 10 | 12 | 11 | 11 | 1.0 | −0.4 | 0.6 |
| Mn | 4 | 5 | 4 | 4 | 0.6 | −0.1 | 0.5 |
| Si | 0.9 | 1 | 0.7 | 0.8 | 0.2 | −0.1 | 0.2 |

The benchmark values have been included in the table for each element. All data is presented with the unnormalized values and rounded off to no decimals, except for silicon and the deviation values. If segregation would have occurred, there would be a significant difference between the fractions. The top fraction deviates the most from the other fractions, with significant negative deviation for oxygen and sodium and significant positive deviation for chlorine. Negative and positive deviation indicates if more, or less has been measured. Oxygen and sodium are both present in sodium chlorate and sodium metasilicate, chlorine is only present in sodium chlorate. Silicon deviates only slightly and not significantly. Chlorine has a different type of deviation than oxygen and sodium, indicating that sodium metasilicate segregated towards the middle and bottom fraction and that more sodium chlorate was left behind in the top fraction compared to the rest of the powder mixture. Silicon is only present for a small amount, which could explain why the difference is not significant since segregation would not be noticed easily. Copper has the most chance to segregate, due to its high skeletal density. Nevertheless, there is no significant segregation of copper. Copper, manganese, and silicon have a slight negative deviation, but still within acceptable range.

### Example II—Granulation

A next step in producing a candle can be granulation of the powder mixture.

The powder mixture can be granulated using the disc granulator. In order to assess what is the best angle under which granulation should occur, a Hosokawa Powder tester has been used to determine the co-called angle of repose for the powder mixture. Powder is in a controlled fashion transformed into a heap and the angle that this heap makes with the base is the angle of repose. The angle was found to be between 55 and 60 degrees, on average around 57.7 degrees.

A control experiment was made to see if granulating the powder had a significant effect on the porosity of the tablet. We have also pressed tablets from non-granulated and only wetted powder. However, it was found that the water was not distributed evenly throughout the powder mixture. The water was sprayed on top of the powder bed and could not penetrate all of the powder without mixing. During an attempt to mix the water with the powder, it started to granulate which was not desirable for the benchmark experiment. Using the granules, several tablets were prepared at different compaction pressures. The porosity values of these tablets can be found in the table below.

| | | Porosity % | | |
|---|---|---|---|---|
| Tablet | bar | a | b | Average |
| G5N2 | 3 | 32.8 | 29.7 | 31 |
| G5N4 | 1 | 30.9 | 33.9 | 32 |
| G5N5 | 0.6 | 36.6 | 37.3 | 37 |

Drying the granules before compacting seems to make the process more difficult. Therefore, wet compression seems to be more appropriate.

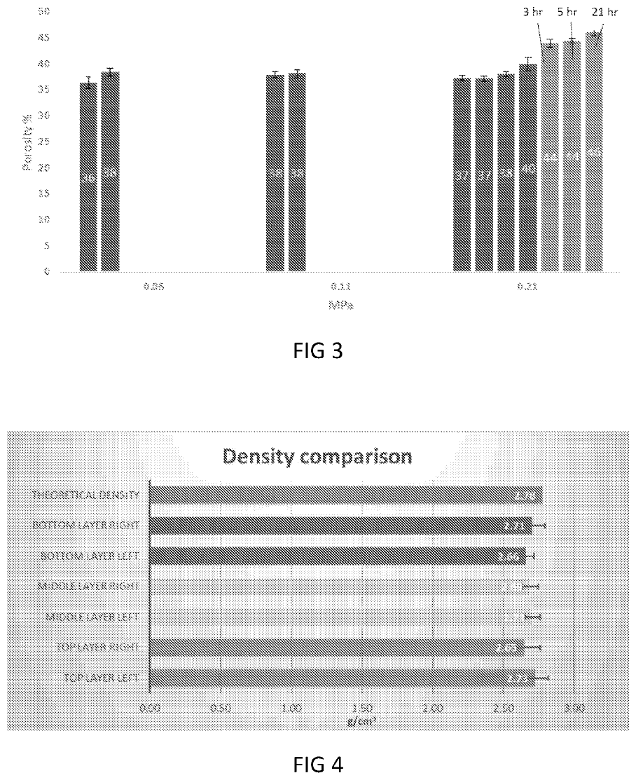

Another series of tablets were made, keeping the importance of time in mind and changing the angle of the disc to 60 degrees. The results of this series can be found in FIG. 3. All tablets were made from the same granule batch and all tablets were pressed immediately after granulation, except for the columns marked in blue. These were pressed 3 hours, 5 hours, and 21 hours after granulation respectively.

### Example III—Powder Treatment: Milling and Mixing Further Optimisation

A Diosna P1/6 high shear mixer/granulator was used to mix and granulate in the same bowl. It has the option to work with bowl volumes of 1 up to 6 L.

A Retsch ultra-centrifugal mill was used to mill with much higher throughput compared to the kitchen-type milling and mixing equipment and it provides a selected size distribution by the incorporation of a sieve screen in the instrument.

Around 500 g of sodium chlorate (NaClO₃) and 50 g of sodium metasilicate (Na₂SiO₃) were separately milled in the ultra-centrifugal mill. The sieve used on the centrifugal mill had a mesh size of 500 μm when grinding sodium chlorate and 125 μm when grinding sodium metasilicate. The usage of a sieve with a relatively large mesh size for grinding the sodium chlorate (500 μm instead of 125 μm) is a result of the clogging of the smaller mesh sizes when using sodium chlorate.

With the help of laser scattering, the volume particle size distribution of all the separate components and the compound mixture were determined. The volume particle size distribution of the compound mixture after mixing was determined.

All the components present show partial similarities in particle size according to the laser scattering analysis. This can be concluded looking at the overlay visible around the particle sizes variating from 10 to 100 μm. The MnO₂ particles show a very broad volume particle size distribution ranging from 1 to 100 μm. The MnO₂ and NaClO₃ particles show particle sizes of about 1000 μm and above.

After grinding, the components (NaClO₃, Na₂SiO₃, Cu and MnO₂) were weighed as follows:

| Compound | Weight (g) | Weight (%) |
|---|---|---|
| NaClO₃ | 495.00 | 79% |
| Cu | 87.72 | 14% |
| MnO₂ | 18.80 | 3% |
| Na₂SiO₃ | 25.06 | 4% |

The individual components were mixed using the Diosna P1/6 in a 1 L tank for 15 minutes using a rotor speed of 300 rpm and chopper speed of 1200 rpm. After the mixing process, the lid of the tank was opened and two samples (on opposite sides) of about 2 ml were taken from the top layer using a spoon (2 ml). About half of the volume of the tank was gently removed using a scoop, then again two samples of about 2 ml were taken on opposite sides. The remaining volume was removed using a scoop until only a small layer on the bottom was left, again two samples of about 2 ml were taken on opposite sides. These samples were used to conduct further analyses using SEM-EDX and helium pycnometry.

Also, another small sample was taken from the middle of the tank to analyse the volume particle size distribution of the mixture using laser scattering. The volume particle size distribution of the compound mixture (black line in the laser scattering volume particle size distribution drawing) is very similar to the volume particle size distribution of NaClO₃ (green line). This makes sense considering the ratio (around 80%) of NaClO₃ present in the compound mixture. Also, previously observed agglomerates of MnO₂ and NaClO₃ do not seem to appear (particle sizes above or around 1000 μm) in the compound mixture.

Using helium pycnometry, the skeletal density of all the six fractions taken from the mixing batch was separately analysed and then compared with each other and the calculated mean skeletal density of the mixture (which was calculated using the measured skeletal density of each component). The heaviness of a compound is defined by its skeletal density, which in this case means that Cu with a skeletal density of 8.96 g/cm³ and MnO₂ with a skeletal density of 5.03 g/cm³ would be the heaviest compounds present in the mixture. The bar graph of FIG. 4 shows a visual representation of the measured skeletal density of all layers and the calculated mean skeletal density of the mixture. It also shows the confidence interval of the skeletal density measurements using three times the standard deviation (plus and minus the original measurements) calculated from the Shewhart card related to the used microcell of the helium pycnometer.

With the use of SEM-EDX, the elemental composition of the layer samples was determined and compared with the theoretically calculated elemental composition of the component mix batch. The table below describes the compound composition and the calculated theoretical elemental composition of the mixture. The normalized SEM-EDX analyses compared with the theoretical values of the elemental composition are presented in the next bar graph of FIG. 5. The elemental analyses per element differ minimally in terms of the analysed layers. This confirms homogeneous mixing. When comparing the analyses of the layers and the theoretical calculated elemental composition, there is a clear difference visible. This has been discussed before as there seem to be some systematic errors in the SEM-EDX analysis when comparing experimental and theoretical data.

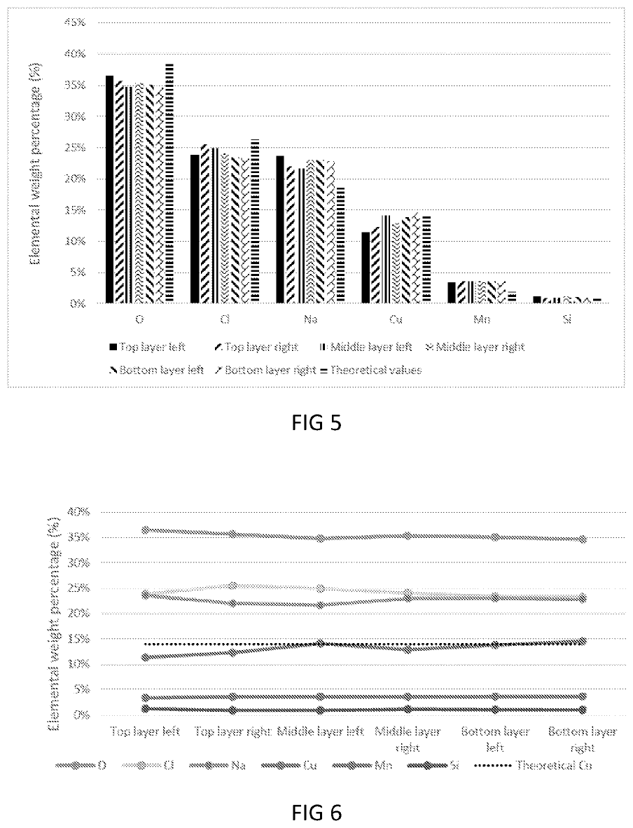

Even though there are differences between the theoretical elemental composition and the elemental composition of the layers, based on the consistency in the results among the various layers in terms of elemental weight percentage, it can be concluded that the mixture is homogeneous. FIG. 6 uses the same data but gives a better visual representation of the elemental analysis between each layer organized from top to bottom.

### Example IV—Granulation in the Diosna Equipment

The operating window, as well as the optimization of the granulation technique, were determined by visually analysing the physical state of the produced granules. The operation window describes the window in which visually decent (round, smooth and not crumbly) granules are processed which depends amongst other variables on the ratio of water added. This analysis was thus conducted by (visually) comparing the outcome of the granules in terms of physical properties such as crumbliness and shape whilst variating the percentage of water added. The outcome per experiment in terms of granulation is summarized in the table below:

| | Weight | Rotor/ | Visual | |
|---|---|---|---|---|
| Sample | percentage | chopper | granule | |
| number | H₂O | speed (rpm) | formation | Observations |
| 1 | 1.18% | 100/400 | yes | Extremely crumbly, |
| | | | | possibly not useful for |
| | | | | tableting |
| 2 | 2.50% | 100/400 | yes | Smooth relatively small |
| | | | | granules |
| 3 | 3.55% | 100/400 | yes | Smooth relatively small |
| | | | | granules |
| 4 | 4.23% | 100/400 | yes | Smooth relatively small |
| | | | | granules |
| 5 | 4.90% | 100/400 | yes | Smooth relatively small |
| | | | | granules |
| 6 | 5.74% | 100/400 | yes | Smooth relatively small |
| | | | | granules |
| 7 | 6.97% | 100/400 | yes | Smooth relatively small |
| | | | | granules |
| 8 | 7.96% | 100/400 | no | Saturation occurred |
| | | | | (muddy granules) |

The table indicates an operating window of around 2.5-7% water addition in weight percentage as a whole of the component mixture bulk.

Based on these observation a safe and average value of 5% water has been chosen to further investigate other granulating parameters. During this experiment, the chopper speed was both doubled and halved (expressed in revolutions per minute/rpm), the same was done with the rotor speed whilst the mass percentage of water added was kept at a constant 5%. The results of this experiment are shown in the table below, also containing a short description to describe the granules in terms of physical state.

The observations made as described in the table above suggest that the lowering of the rotor or chopper speed will enlarge the granules in terms of size.

The yield of granules using the increased chopper/rotor speed is relatively low. This is as a result of the accumulation of powder mixture on the walls of the granulation tank. The process of accumulation is probably induced by the number of times the powder comes in contact with the walls of the tank which is increased by increasing the rotor speed. An explanation for the accumulation using just a higher chopper speed could be that the water is being taken out of the granules (because of the relatively high energetic impact of the chopper) onto the wall causing the wall to get sticky and inducing the accumulation process.

The results suggest that relatively low chopper and rotor speeds will result in relatively large (not so dense) granules also obtaining relatively high yield. The increase of either the rotor or chopper speed will result in smaller (denser) granules with a relatively low yield in terms of granules.

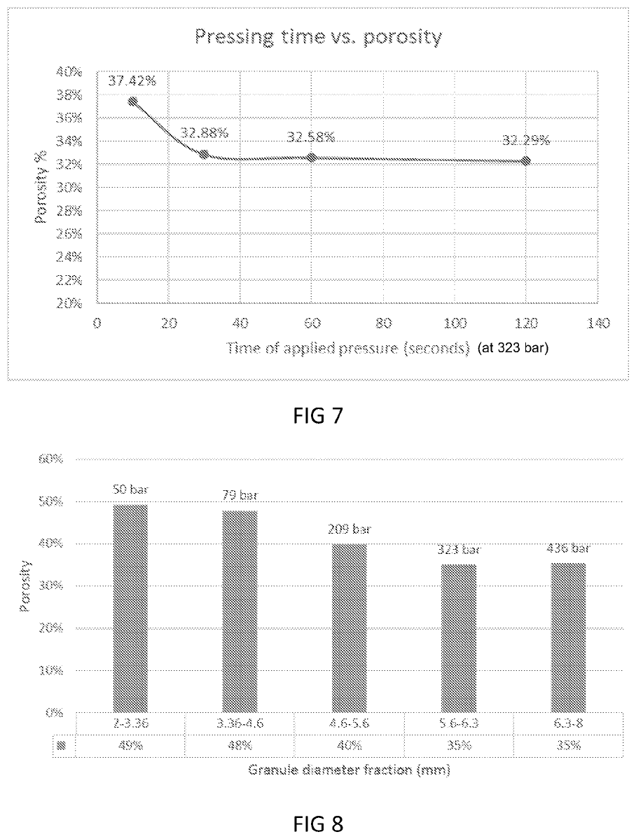

The duration of the pressure during the pressing of a tablet is a variable that was investigated, in order to prevent variations in porosity because of pressing duration. The relation between the pressing time and the porosity is shown in FIG. 7 and shows the results of the conducted porosity measurements where 323 bars of pressure was applied for 10, 30, 60 and 120 seconds on granules, which had a drying time of over five weeks (dry and hardened granules).

A tablet with the narrow volume particle size distribution is preferable over the use of a tablet pressed out of a relatively wide volume particle size distribution.

When the size of the granules increases, substantially more pressure was found to be needed in order to crush the granule.

Further research towards the relationship between the granule size and the porosity was conducted by pressing the granules with the minimum amount of pressure needed in order to create relatively high-quality tablets whilst varying the granule size (5 fractions). A relatively high-quality tablet defines itself by a stable, non-crumbly, smooth-edged physical state for usage as chemical oxygen candle. The granule used for the pressing of the tablets had a drying time starting at a minimum of 5 weeks. Pressing granules at different sizes (fractions) using a minimum amount of pressure to create high-quality tablets should give a representative and reliable outcome in terms of porosity of the tablets. FIG. 8 indicates a found relation between porosity versus granule diameter fraction under high-quality tablet circumstances.

A decline in porosity is visible when the granule diameter increases. Also, the pressure needed. The tablets so far were in a relatively crumbly state.

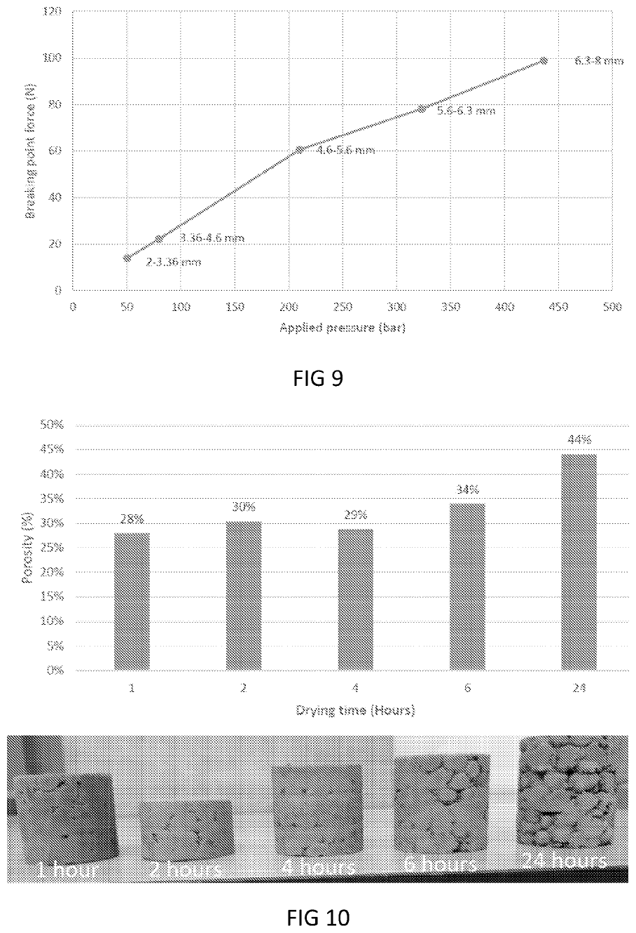

All the granules used (with a drying time with a minimum of 5 weeks) did visually not tend to deform at all when pressure was applied, which is confirmed by the relatively crumbly state of all tablets. The pressure used to form the granules into a relatively high quality tablets has been plotted versus the crushing strength of the granules per sieved fraction. The mean granule crushing strength versus the applied pressure is shown in FIG. 9.

The drying time of the granules, is related to their water content. The water content is a parameter that was evaluated by measuring the drying time.

The granules were sieved right after granulation in order to obtain granules fraction of different granule particle sizes. This was done to exclude the parameter of granule particle size (distribution) influencing the quality of the candle. The granule particle crushing strength (in Newton) and diameter of the granules were measured after 1, 2, 4, 6, 24, 48 and 72 hours of drying time. The mass of a separate small but representative bulk of granules was also weighed during the same drying time intervals in order to confirm that the composition (the amount of water present) changes over the time that granules are dried. The mass loss as a percentage of the whole mass has been plotted in the next figure. Because mean values were used (out of series of 20 measurements), a 95% confidence interval was calculated and added to the crushing strength figure in order to ensure that the mean values give a more representative view of the data.

As a follow-up experiment, the influence of the granule drying time on the porosity and quality of the candle was determined. The relatively low applied pressure (3.75 bar), as well as the pressuring time (2 minutes), was kept constant whilst the drying time of the granules was variated. The eventual candles were pressed using the stapling method, the granules were pressed after 1, 2, 4, 6 and 24 hours of drying time. The results of the porosity measurements are represented in FIG. 10, also showing pictures of the resulting tablets.

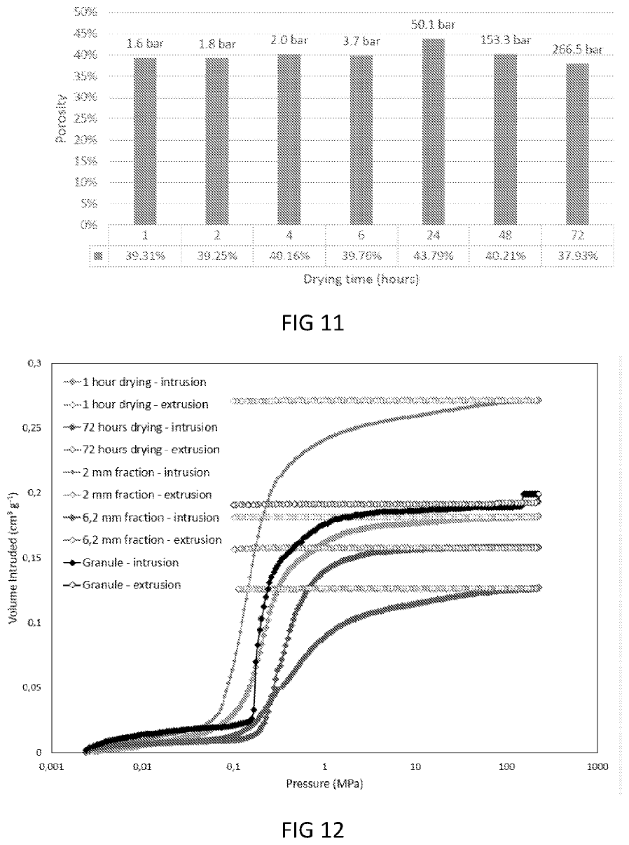

To get more insight into the relationship between the drying time and the porosity over a longer drying time period than just 4 hours, tablets were made by pressing the granules with the minimum amount of pressure needed in order to create relatively high-quality tablet (no candle). A relatively high-quality tablet was defined as a stable, non-crumbly, smooth-edged physical state. The granules were sieved right after granulation to control the volume particle size distribution. This was done to exclude the parameter of particle size (distribution) influencing the quality of the candle. By pressing granules at different drying times using a minimum amount of pressure to create high-quality tablets should give a representative and reliable outcome in terms of porosity of the tablets. Therefore, using this method, the relationship between granule drying time and tablet porosity can probably be mapped adequately. FIG. 11 shows the results of the obtained porosity as a function of the drying time in hours considering qualitatively high-quality tablets.

The results (being the intrusion curves) of the conducted mercury intrusion porosimetry measurements are displayed in FIG. 12. Plotted is the cumulative intrusion volume as a function of pressure. What can be concluded from the intrusion curves is that the intruded volume of the 2 mm fraction tablets is clearly the highest whereas that of the tablet produced from the 6.2 mm granules is clearly the lowest. This clearly shows the impact of the size of the granules coupled to pressure required for obtaining a good tablet and the obtained porosity, i.e. much lower for the larger granules of 6.2 mm.

Concerning drying time, the differences is not so dramatic: longer dried granules (72 hours) provide a little lower intrusion than the shorter dried counterparts (1 hour drying). These results suggest from the porosity view point smaller granules and shorter dried granules are beneficial for a higher and better controlled porosity.

The next table describes the porosity of each tablet measured using helium pycnometry, mercury intrusion porosimetry, the difference between these measurements and the percentage of porosity that is measured using mercury intrusion porosimetry as opposed to the porosity measured using helium pycnometry. Note that there are limitations using this combination of helium pycnometry and mercury porosimetry technique as the determination of pore sizes is limited to a minimum of 0.006 μm and a maximum of 800 μm, respectively.

| | Porosity | | | Percentage porosity |
|---|---|---|---|---|
| | measured | | | measured with MIP |
| | using mercury | Porosity | | (opposed to porosity |
| | intrusion | measured using | Difference in | measured using |
| Granules used | porosimetry | helium | measured | helium pycnometry) |
| to make tablet | (%) | pycnometry (%) | porosity (%) | (%) |
| 2 mm (sieved fraction) | 42.4 | 49.2 | 6.8 | 86 |
| 6.3 mm (sieved fraction) | 25.7 | 35.4 | 9.7 | 73 |
| 1 hour drying time | 33.3 | 39.3 | 6.0 | 85 |
| 72 hour drying time | 30.0 | 37.9 | 7.9 | 79 |
| Granule | 33.8 | — | — | — |

The porosity measured by mercury intrusion is indeed much higher for the tablet prepared from 2 mm sized granules (porosity 42%) than for 6.3 mm sized granules (porosity 26%). In agreement with the observations over the intrusion curves, the porosity for the 1 hour dried tablet (porosity 39%) is hardly different from that of the 72 hours dried tablet (porosity 38%).

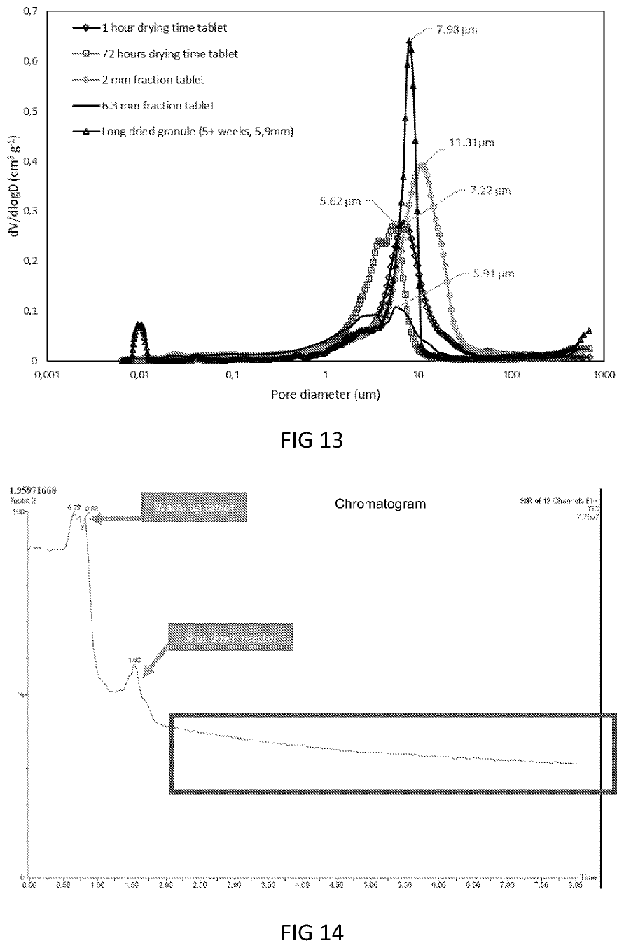

FIG. 13 shows the pore size distributions derived from the intrusion curves in which the differential volume per gram material is plotted versus the pore diameter in μm.

The graph in FIG. 13 shows that the pores within an unprocessed granule defines itself by a diameter of approximately 8 μm (black line). The green line (2 mm granule tablet) shows that most of the porosity originated from pores with a diameter of approximately 11 μm, slightly larger than the single granule pore structure.

The table above further illustrates a difference of measured porosity between helium pycnometry and mercury intrusion porosimetry. The porosity measured by means of mercury intrusion porosimetry seems about 15 to 25% lower than the porosity measurements using helium pycnometry. It seems that mercury intrusion porosimetry measures pore sizes smaller than 800 μm.

Based on the results it seems that around 80 percent of the porosity within all measured tablets using mercury intrusion porosimetry is originated from intergranular spaces (pores). The pores of the tablet made out of 2 mm long-dried granules seem to have a larger mean pore size than the granule. The tablets made out of relatively short dried granules seem to have very similar properties in terms of intergranular space size compared to the unprocessed granule. Also increasing the amount of pressure applied will result in a porosity drop and will narrow the pore sizes (and probably void spaces) of the tablet independently if the granules were relatively long dried (>5 weeks) or short dried (<72 hours).

| | Height | | Volume Tablet | Skeletal | Porosity |
|---|---|---|---|---|---|
| Tablet | (cm) | Radius (cm) | (cm\hat{ }3) | volume (mL) | (%) |
| 1 | 1.30 | 1.58 | 10.17 | 6.41 | 36.93 |
| 7 | 1.40 | 1.57 | 10.82 | 6.82 | 36.99 |
| 12 | 1.29 | 1.57 | 10.02 | 6.34 | 36.70 |
| 17 | 1.29 | 1.58 | 10.08 | 6.50 | 35.54 |
| 18 | 0.85 | 1.63 | 7.12 | 4.07 | 42.90 |
| 21 | 0.87 | 1.63 | 7.27 | 4.14 | 43.12 |

Tablets 1, 7, 12 and 17 come from a batch with the composition as follows: 79% NaClO₃, 14% Cu, 3% MnO₂ and 4% Na₂SiO₃. Tablets 18 and 21 were made with one composition of 58% NaClO₃, 35% Cu, 3% MnO₂ and 4% Na₂SiO₃.

### Example V—Measuring of Burn Conditions

Thermocouples are used to measure the temperature during the reaction side ports of the reactor. There are three thermocouples connected to the reactor and one thermocouple at the top. The first thermocouple was under a tablet, so in direct contact with the flame but at a small distance (±0.5 cm) from the tablet. The second thermocouple is located about 2 cm above the tablet, the third thermocouple at 4 cm and the fourth and last thermocouple is 26 cm away from the top of the tablet. The different thermocouples above the tablet measure the temperature of the gas released tablet, to be able to demonstrate the cooling capacity of the tablet in which the thermocouple is on 2 cm the most important indication about the cooling effect of the tablet.

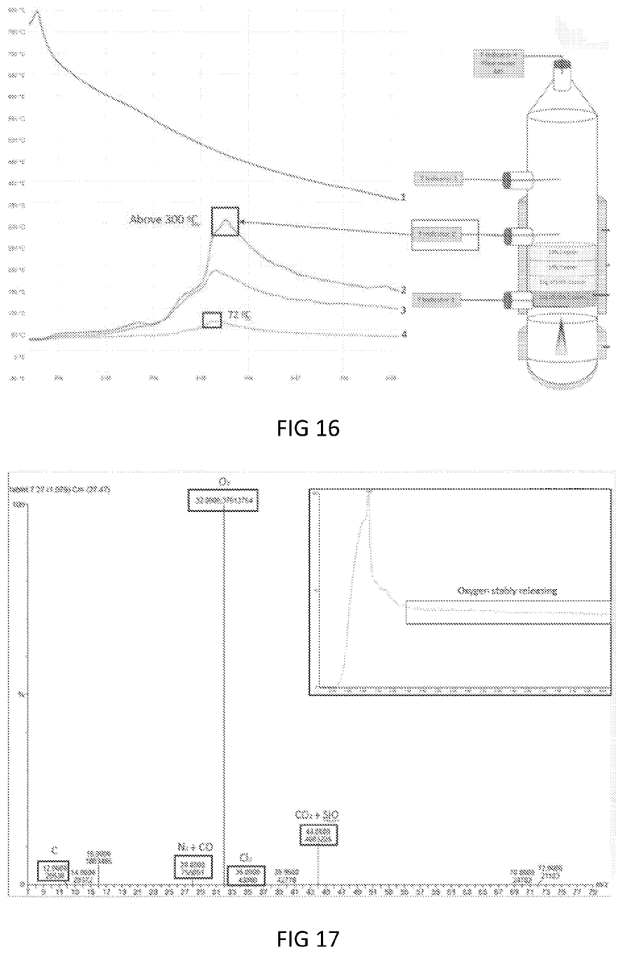

In FIG. 16, the temperature gradient is shown by the combustion of a tablet. This is the blue line shows that the tablet burns at a temperature of 585° C., the second peak is its combustion front that moves over the tablet. The decrease of the line has to do with the movement of the combustion front away from the lower thermocouple. The combustion front is at the top after two and a half minutes of the tablet, the temperature of the gas was thereby influenced and thereby came to 147° C. At the same time, the temperature at 4 cm from the tablet was 115° C. and at the highest point 26 cm above the tablet 40° C.

It was found that there is a cooling effect of the porous structure of the tablet. The tablets used for these experiments were no higher than two cm and had a cooling effect of around 400° C. while also adding heat to the environment was issued.

A mass spectrometer was calibrated to expected values for the composition of the released gas. The capillary that was used was 7.5 m long so that the detector was not overloaded by the amount of sample which enters the mass spectrometer. The tablet was heated with a gas burner at a distance of about 8 cm for about 20 seconds. As soon as the tablet burned, the reactor was sealed with a cap on the bottom and one sharpener clamp. After complete burning of the tablet, the mass spectrometer was stopped with the set of a helium flow. To determine the composition of the released gas, four tablets were measured with a set for the multiplier of 250 V. In the chromatogram of FIG. 14, the red frame indicates the data range which is used for determining the TIC values for the different m/z values.

In the first minute, the tablet is heated with the gas burner. Warming up causes a peak at 0.81 minutes. At 1.66 minutes, the tablet is burning and the reactor is on sealed so that the gas released can only go towards the mass spectrometer. After stabilization of the signal, the line in the red frame ends slowly because the tablet has stopped burning there no more gas is released. From the red frame, a mass spectrum is then generated of the different m/z values, as can be seen in FIG. 17. In the mass spectrum, a TIC value is indicated per m/z value. To calculate the oxygen concentration, the TIC value is at m/z value of 32.1. The TIC value at m/z of 44 can be considered as CO₂ or SiO. For chlorine gas, the TIC values of m/z should be 72 and 70.

### Example VI—Burning of a Candle of Tablets

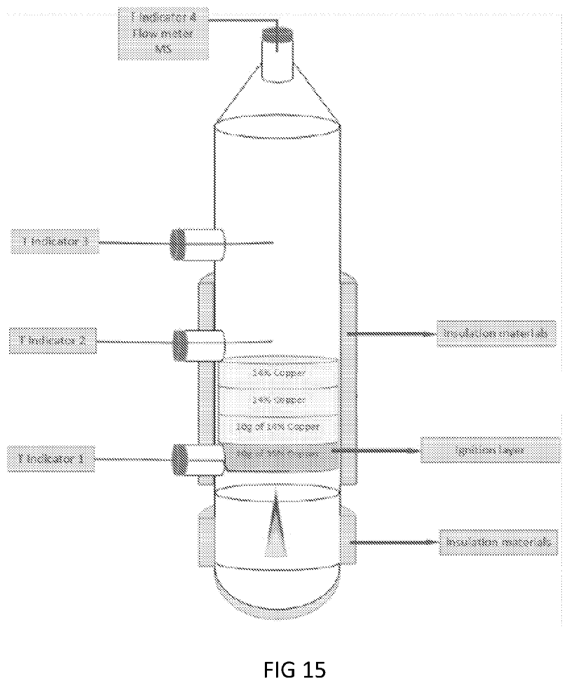

In this step, the candle for oxygen generator device contains 1 (upstream) tablet with 35% of copper and 3 (downstream) tablets providing oxygen producing layers with 14% of copper. The setup was the same as in the second step. One layer of thermal insulation was wrapped surrounding the reaction tube. The schematic diagram is shown in FIG. 15.

The oxygen generator device is defined by the outlet gas temperature, gas flow rate, and oxygen concentration. In the depicted device, four temperature indicators are installed in the reaction tube. They can measure the temperature of the flame, 2 cm above candle, 4 cm above candle and 8 cm above the candle. The gas flow rate has been measured by the electronic flow rate meter with a range of 1-50 L/min. The accuracy level of the flow rate meter is two decimal places. The purity of oxygen is measured by the mass spectrometer. The spectrum m/z value of 32 represent the oxygen component in the producing gas.

Temperature

Two different methods to measure the temperature were used. First one is to raise the tablet with a steel ring to a certain height so that one temperature indicator can go inside of the tablet. In order to achieve this, a small hole was drilled in the side of the tablet. In this way, the inner tablet temperature profile can be made. In the figure below, the schematic sketch of the set-up and the temperature profile obtained upon burning of the tablet has been shown. The main purpose of this measurement is to check if the heat inside of the tablet is sufficient to support the further burning. As is shown in the figure above, the red line is the temperature inside of the tablet. When the burning started, the temperature inside the starting tablet raised rapidly. The peak temperature point is above 700° C. An approximate 300° C. is needed for decomposition of the chlorate and oxidation of the copper.

The second method is to produce an overview of all the temperatures from bottom to top in the reactor tube. Indicator 2 is set right above the top layer of the candle. In FIG. 16, the schematic sketch of the measurement and the temperature profile of the overview temperature of the tablet burning has been listed.

As is shown in FIG. 16, when the candle almost burned to the top surface, the temperature was above 300° C., which means that when the candle finished the burning, there was still extra heat above 300° C. for copper to oxidize. By tracking this phenomenon, it seems that piling up of tablets is possible.

The reaction tube is connected to the mass spectrometer with a capillary and with flow meter. When the candle is burning, a little amount of the produced gas is sucked via the capillary to the mass spectrometer and it is analysed.

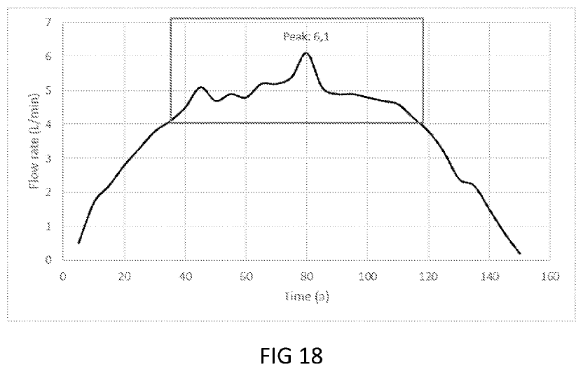

The results from mass spectrometer are presented in two ways: a chromatogram and a spectrum. Examples of the chromatogram and the spectrum result have been shown in FIG. 17. On the top right of the figure below is the chromatogram, in which the x-axis is expressed as the retention time, it shows the amount of time needed for the components to reach the mass spectrometer detector. In FIG. 18, with increasing retention time, the TIC values go higher and reach a maximum with multiple components including N₂, Ar, O₂, CO₂ and so on. Then it reaches a stable line with high concentration of one component signal, induced by oxygen in this case. Therefore, in order to measure the real-time concentration value of oxygen, the stable “baseline” needs to be chosen for further evaluation. The bottom left part in the figure above records the TIC values for certain m/z value components under the chosen stable oxygen line. The m/z values of 32 and 16 represent oxygen. The m/z value of 28 can be both N₂ or CO. The same applies to the m/z value of 44, it can be SiO or CO₂. In order to distinguish and quantify the toxic gas CO, low concentration toxic gas calibration lines need to be recorded. In the window in FIG. 18, the real-time flow of gas produced during burning of a candle is depicted. The flow reaches a high stable rate (above 4 L/min) for around 80 seconds. The peak point of the flow rate is 6.1 L/min. An efficient burning time can be observed from 20-120 seconds. During this period, the average flow rate can be calculated as 4.2 L/min. With improved thermal insulation setup, the average flow rate is higher.

Since here we work with a candle diameter of 31 mm, and the average flow rate is around 4.2 L/min, by upscaling to the candle diameter of 40 mm, the average flow rate can reach 6 L/min.

### Example VII—Start Tablet Comprising Iron (Fe)

Iron (Fe) addition may result in a higher burning temperature. It indicates that addition of Fe may give a better result in starter tablets. Some experiments were done using the previously indicated tablets with various amounts of (relatively pure) iron—Fe.

Results below show that an iron (Fe) contents equal or higher than 4.5% and lower than 7% wt, in particular 4.5-6%, (see table below) results in stable starter tablet performance.

In particular, at some amounts 0.5% iron (Fe) reduction even resulted in a temperature drop of 60° C.

Further experiments combined copper (Cu) and iron (Fe). This shows that selecting an amount of 4.5% iron (Fe) and more than 5% copper (Cu), and in particular at least 7.5% copper (Cu), in particular more than 10% copper (Cu) to give the best results, all within the indicated amounts of the self-sustaining decomposition additive of 7-22%, in particular here 15-18% wt.

| Fe content | Observation | Flow rate |
|---|---|---|
| 3% | No burning. | No flow |
| 4.5% | Burning started, but no | Initially 6 L/min |
| | continuous burning. | |
| 5% | Stable and controllable flow. | 8-9 L/min |
| 7% | Strong flow but not stable. | Above 20 L/min |
| 14% | Extremely fierce reaction | Excessive flow rate, could |
| | | not be measured |

2) various copper (Cu) percentages and with 4.5% iron (Fe):

| Fe and Cu content | Observation | Flow rate |
|---|---|---|
| 4.5% Fe with 5% Cu | Burn started, but no | Initially 6 L/min |
| | continuous burning. | |
| 4.5% Fe with 10% Cu | Stable and controllable flow. | 6-8 L/min |

A conclusion is that 4.5% iron (Fe) with 10% copper (Cu) works well, and 7% w/w or more iron (Fe) results in unstable burning in this composition.
To assess the effect of fuel on the combustion temperature, tablets with two different iron content, i.e., with 4.75% and 4.25% (w/w) were tested. The peak temperature obtained are from the indicator 3 thermocouple (TC) (1 cm above the tablet, in indicator 2 in the setup of FIG. 15).

| | | | | | | Peak |
|---|---|---|---|---|---|---|
| | Fe | Cu | NaClO₃ | MnO₂ | Na₂SiO₃ | temperature |
| Tablet 1 | 4.75% | 10.25% | 78.75% | 3.25% | 3% | 550° C. |
| Tablet 2 | 4.25% | 10.25% | 79.25% | 3.25% | 3% | 490° C. |

A small decrease of the iron content changed the temperature substantial, with 0.5% Fe reduction resulting in 60° C. temp drop.

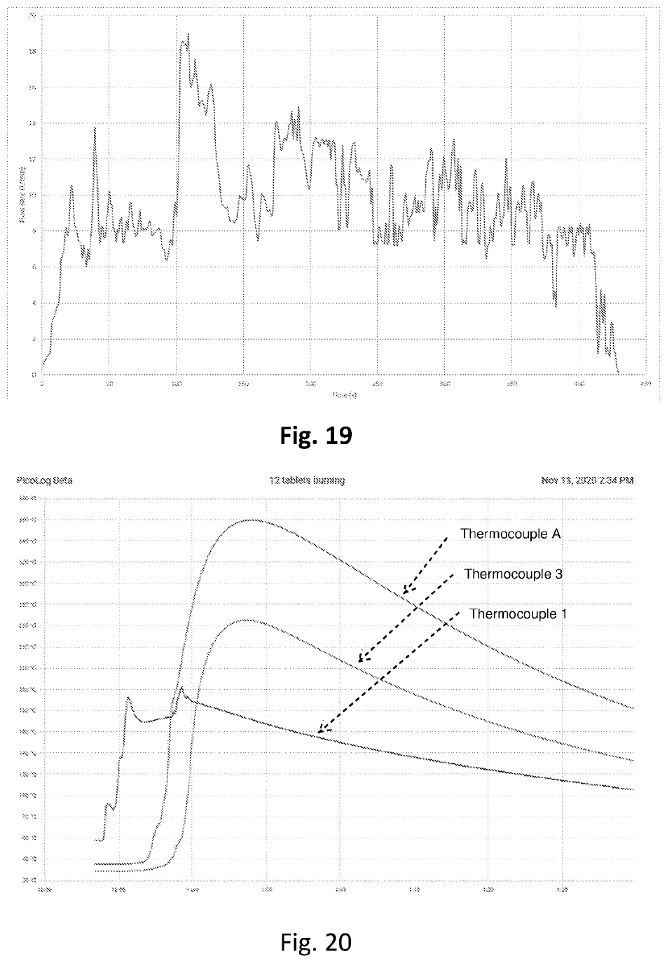

For the tablets comprising 4.25% (as always in these experiments, w/w) iron (Fe), a stack of 12 tablets was burned, resulting in around 420 second of burning at a flow of more than 6 L/min of oxygen. See FIG. 19 for the results. The temperature of an upper thermocouple remained below 270° C. See FIG. 20, using the setup of FIG. 15, with thermocouple 1, thermocouple 3 and an additional thermocouple A between thermocouple 1 and thermocouple 3.

### Example VIII—the Effect of Molybdenum (Mo)/Aluminium (Al) Addition/

In further experiments, the effect of adding more than 2% w/w Mo and more than 10% w/w Cu, in particular 3% w/w Mo was evaluated. Furthermore, the use of aluminium was evaluated. Measurements of the resulting gas in Mo comprising tablets shows more than 45 ppm Cl₂. The burning pattern can be more constant than when using iron (Fe) like in example VII. The tablets comprising Molybdenum (Mo) showed a slightly lower burning temperature than the iron-comprising tablets of Example VII, especially at the start.

Furthermore, Mo was used in experiments in the self-sustaining decomposition additive:
Test set 2a: Fe-based starter tablet+2 tablets with 2% of Mo. result: no burning.
Test set 2b: Fe-based starter tablet+2 tablets with 3% of Mo and 10% Cu. Result: 150-160 seconds of burning producing around 6 L/min flowrate of oxygen.
Test set 2c: Fe-based starter tablet+2 tablets with 3.5% of Mo and 10% Cu. In the burning test, 3 tablets, containing one 4.25% iron starter tablets and two 3.5% Mo/10% Cu, have been used. The burning time was around 120 seconds, with almost 80 seconds with 8 L/min oxygen production.
   The use of Mo resulted in stable burning. Some amounts of Cl₂ were measured.
   In this further experiment the amount of self-sustaining decomposition additive was lowered to 15.75%.
   In this composition, in particular the amount of catalyst was lowered to 1.5%.
   Al Mixture was also tried in the self-sustaining decomposition additive.
Test set 1a: Starter tablet as currently used+2 tablets with 1% of Al.
Test set 1b: Starter tablet as currently used+2 tablets with 1.5% of Al and 10% Cu.

Results:

Test set 1a: Theoretically, the oxidation heat for Al is almost 4 times higher than for Fe, therefore, 1% Al was used in the tablets in order to achieve a similar oxidation heat as for 4% Fe and to avoid excessive/uncontrolled burning as seen in previous Fe optimisation studies. For the 1% Al tablets, the burning stopped in the early stage after trying to ignite directly with the flame in the fume cabinet.

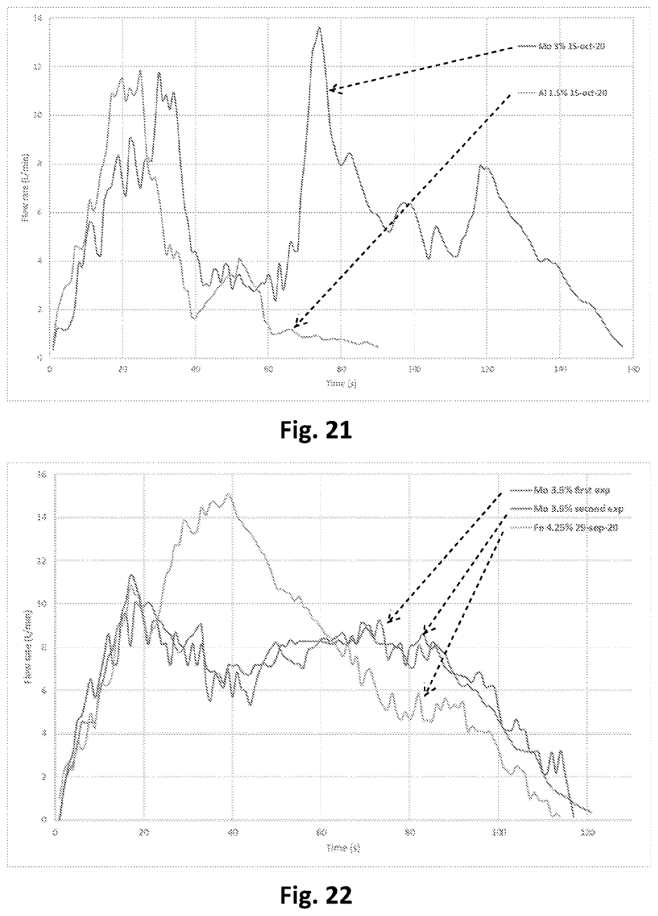

Meanwhile, there was no sign of burning in the enclosed combustion system.
Test set 1b: Subsequently, 1.5% Al was used in the tablets in order to achieve a theoretical equivalent of 6% Fe oxidation heat. Also, due to the previous experience on the lack of a fuel distribution in the tablets, 10% Cu has been added in the tablets this time in order to create a fuel more homogeneous fuel distribution. In tests, a tablet having 1.5% Al with 10% Cu tablet only burned one-third. Theoretically, the oxidation of Al should occur in the temperature range around 500-600° C. So in theory, the heat for Al to start the oxidation, i.e. burning, is much higher than for Fe. Therefore, it seems that the heat from the starter tablet burning is not enough for the Al to obtain progressive oxidation. Meanwhile, the combustion temperature for Al can be very high. The variation between the 1.5% Al and 3% Mo both with 10% Cu can be seen in FIG. 21. Fuel tablet with 3.5% Mo and 10% Cu gives stable results where a pile of three tablets burning was used, see FIG. 22, in both cases an iron-comprising starter tablet was used.

Both fuel tablets give around 120 seconds of burning time. The iron tablets give a fiercer burning activity in general as you can see the peak flow rate for the iron tablet can reach 15 L/min. However, the peak flow rate for the Mo tablets is around 9 L/min. The temperature profile can also provide the information that iron tablets can probably produce more heat during the burning and this results in a higher flow rate. The Mo tablets resulted in a smell in the oxygen, indicating a lower degree of purity. The mass spectrometry (MS) was used first to detect if there is any/how much Cl₂ gas was in the outlet gas. The results from the MS shows that there is potentially Cl₂ gas in the outlet gas, which by calculation is more than 45 ppm.

### Example IX—Granule Size

The effect of granule size when preparing tablets was tested again. Tablets were produced with the following composition (% w/w):
Fe 4.5%, Cu 10%, Binder NaSiO₃ 4%, Catalyst MnO₂ 3%, Oxygen source NaClO₃ 78.5%.

Various sieving meshes were used to select the different granule sizes.

The rest of the tablet fabrication process was the same as example IV. In order to increase the repeatability of the process, we replaced the manual water dosing with an infusion pump dosing system. With this setup, the dosing rate can accurately be adjusted and fully controlled leading to a more repeatable manufacturing process. Moisture contents was lowered to below 0.5%. In particular embodiments, the drying temperature was 160° C. and drying time 2 hours.

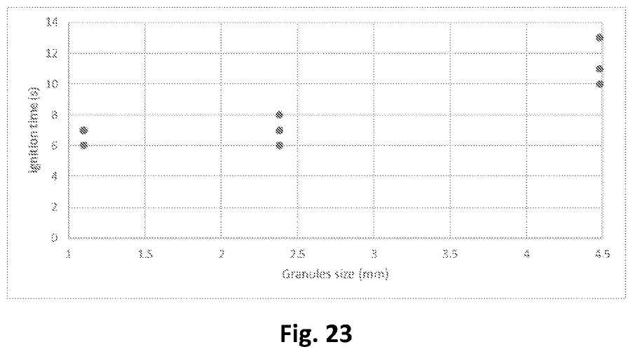

Experimental data shows that making tablets from 1-4 mm granule size result in a reduced pressure differential across the tablets than 3.36-5.6 mm granule size tablets. This allows better stacking of tablets. While maintaining sufficient burning results. In particular at higher flow rate, the difference becomes larger. To give a clearer and direct impression on the new tablets, FIG. 23 shows how fast the tablets can be ignited. Medium/small granules tablets can be ignited faster, which is around 6-8 seconds, FIG. 23. Big granules tablets normally have to be ignited a second time because they often stop burning after first ignition. This occurs due to the morphology of the bottom part. The tablets produced from the big granules, out of 4 tablets tested 2 tablets stopped burning. This likely can be explained by the inconsistent morphology inside of the tablets and most of the gas probably went out of the tablet during burning, thereby causing too much heat loss.

### Example X—Gas Purity

Tablets were produced as mentioned in Example VII. Concentration of oxygen and carbon monoxide/dioxide measured using GC-MS.

The oxygen concentration during burning:

| Tablet | Oxygen concentration |
|---|---|
| 35% Cu | 99.7% |
| 4.5% Fe, 10% Cu | 99.6% |

Carbon monoxide/dioxide concentration:

| Tablet | CO concentration |
|---|---|
| 35% Cu | 33 ppm |
| 4.5% Fe, 10% Cu | 31 ppm |

| Tablet | CO₂ concentration |
|---|---|
| 35% Cu | 81 ppm |
| 4.5% Fe, 10% Cu | 76 ppm |

Furthermore, toxicity was tested with Drager sampling tubes. Using this known method, carbon monoxide is measured at approx. 20 ppm and chlorine at approx. 4-5 ppm.

Further experiments showed that there is a slight influence of binder selection: The tablets/granules quality goes down when using sodium metasilicate anhydrate. It was found that when using sodium metasilicate anhydrate, the binder amount w/w had to be lowered to 3% w/w, which can again produce good quality granules with good tablet morphology and aesthetics. Meanwhile, the other materials keep the same ratios. When using sodium metasilicate pentahydrate, the binder amount was a little higher, around 4% w/w.

In the examples above, the following raw materials were used and processed in the following way, unless explicitly described otherwise, as summarized in the table below.

| | Particle | | |
|---|---|---|---|
| Material | size (μm) | Bought as | Processed |
| Fe | >100 | Sigma Aldrich - Iron, ≥99%, | Sieved to <100 μm |
| | | reduced, powder (fine) | |
| Cu | >75 | Sigma Aldrich - Copper, 99%, | As purchased |
| | | powder | |
| NaSiO₃ | 10-100 | Sigma Aldrich - Sodium | Milled, as in example III by Retsch |
| | | metasilicate, 50-53% | ultra-centrifugal mill with 125 μm |
| | | | sieve. |
| MnO₂ | 1-100 | Emplura - Manganese(IV) | As purchased |
| | | oxide, ≥89%, powder | |
| NaClO₃ | 10-100 | Alfa Aesar - Sodium chlorate, | Milled, as in example III by Retsch |
| | | ≥99%, granular | ultra-centrifugal mill with 500 μm |
| | | | sieve. |

It will also be clear that the above description and drawings are included to illustrate some embodiments of the invention, and not to limit the scope of protection. Starting from this disclosure, many more embodiments will be evident to a skilled person. These embodiments are within the scope of protection and the essence of this invention and are obvious combinations of prior art techniques and the disclosure of this patent.

1. A solid material for generating a flow of oxygen, the solid material comprising a chemical mixture for generating said flow of oxygen, the chemical mixture comprising as chemical components:
1-25% w/w of a self-sustaining decomposition additive, wherein the decomposition additive is selected from the group of copper (Cu), aluminium (Al), magnesium (Mg), zinc (Zn), molybdenum (Mo), manganese (Mn), cobalt (Co), nickel (Ni), iron (Fe), cobalt oxides (Co₂O₃ and Co₃O₄), copper oxide (CuO), iron oxide (Fe₂O₃), zinc oxide (ZnO), manganese oxide (MnO), manganese dioxide (MnO₂), manganese oxide complexes MnₓO_{y}, chrome (Cr), chrome oxides, titanium, titanium oxides, and combinations thereof;
65-97% w/w of an oxygen generating component, wherein the oxygen generating component is selected from the group of alkali chlorates and alkali perchlorates, preferably from lithium perchlorate (LiClO₄), lithium chlorate (LiClO₃), sodium perchlorate (NaClO₄), sodium chlorate (NaClO₃), potassium perchlorate (KClO₄) and potassium chlorate (KClO₃);
2-5% w/w of an inorganic binder;
wherein said weight percentages are based upon the weight of the total solid material, wherein said solid material has a skeletal density of 2.8-3.5 g/cm³ when measured using a helium pycnometer,
wherein said solid material has a porosity of 30-50% when measured using a helium pycnometer, and
wherein in said chemical mixture components are provided as particles having a volume particle size distribution having its peak between 5 and 100 μm when measured using laser scattering.

2. The solid material for generating a flow of oxygen of claim 1, the chemical mixture comprising as chemical components:
7-22% w/w of a self-sustaining decomposition additive, more preferably 10-20% w/w, such as 15-18% w/w, wherein the decomposition additive is selected from the group of copper (Cu), aluminium (Al), magnesium (Mg), zinc (Zn), molybdenum (Mo), manganese (Mn), cobalt (Co), nickel (Ni), iron (Fe), cobalt oxides (Co₂O₃ and Co₃O₄), copper oxide (CuO), iron oxide (Fe₂O₃), zinc oxide (ZnO), manganese oxide (MnO), manganese dioxide (MnO₂), manganese oxide complexes MnₓO_{y}, chrome (Cr), chrome oxides, titanium, titanium oxides, and combinations thereof;
76-88% w/w of an oxygen generating component, more preferably 78-86% w/w, such as 80-83% w/w, wherein the oxygen generating component is selected from the group of alkali chlorates and alkali perchlorates, preferably from lithium perchlorate (LiClO₄), lithium chlorate (LiClO₃), sodium perchlorate (NaClO₄), sodium chlorate (NaClO₃), potassium perchlorate (KClO₄) and potassium chlorate (KClO₃), more preferably from sodium chlorate (NaClO₃), from the group of alkali peroxides and alkali superoxides, preferably from sodium peroxide (Na₂O₂), potassium peroxide (K₂O₂), sodium superoxide (NaO₂) and potassium superoxide (KO₂), and combinations thereof;
2.2-4.5% w/w of an inorganic binder, more preferably 2.5-4.0% w/w, such as 2.7-3.5% w/w, wherein the inorganic binder is preferably selected from Na₂SiO₃, K₂SiO₃, and combinations thereof;
wherein said weight percentages are based upon the weight of the total solid material, wherein said solid material has a skeletal density of 2.85-3.3 g/cm³, more preferably 2.9-3.25 g/cm³, when measured using helium pycnometer,
wherein said solid material has a porosity of 31-40%, even more preferably a porosity of 33-38% when measured using helium pycnometer, and wherein in said chemical mixture components are provided as particles having a volume particle size distribution having its peak between 5 and 100 μm when measured using laser scattering.

3. The solid material of claim 1 or 2, wherein said volume particle size distribution has a lower full width at half maximum (LFWHM) of less than 20 μm at the lower particle size range and a higher full width at half maximum (HFWHM) of less than 50 μm at the higher particle size range,
and preferably having substantially no particles smaller than the self-sustaining decomposition additive particles, such as manganese dioxide particles, and preferably substantially no particles larger than the oxygen generating component particles, such as sodium metasilicate particles, wherein the volume particle size distribution is preferably measured using laser scattering.

4. The solid material of any one of the preceding claims, wherein said particles have at least 60% of a combined volume particle size distribution having its peak between 30-80 μm, preferably wherein said particles have a combined volume particle size distribution having its peak between 33-45 μm.

5. The solid material of any one of the preceding claims, said flow of oxygen comprising less than 100 ppm of Chloride (Cl), preferably less than 10 ppm, more preferably less than 5 ppm, and less than 10 ppm carbon (C), preferably less than 5 ppm, and/or said solid material having a water content of below 1% w/w, preferably below 0.5% w/w, more preferably below 0.2% w/w.

6. The solid material of any one of the preceding claims, wherein said chemical components comprise:
as self-sustaining decomposition additive 5-16% w/w selected from Cu, Fe, and a combination thereof, preferably 10-15% w/w selected from Cu, Fe, and a combination thereof; and 2-4% w/w MnO₂,
as oxygen generating component 75-91% w/w NaClO₃, preferably 78-80% w/w NaClO₃; and
as inorganic binder 2-5% w/w Na₂SiO₃.

7. The solid material of any one of the preceding claims, wherein said solid material has a homogeneity for Cu of better than ±20% from a theoretical value (e.g. the mixtures average amount of Cu) and for chloride to differ less than ±10% from a theoretical value (e.g. the mixtures average amount of Cl).

8. The solid material of any one of the preceding claims, wherein said chemical components are intimately mixed and are preferably pressed into at least one fuel tablet, preferably having a right circle cylindrical shape.

9. A fuel tablet according to claim 8.

10. Fuel tablet according to claim 8 or 9, with a cross-flow cross section area of 1-20 cm², preferably 2-17 cm², and/or a height of 0.5-5 cm, such as 1-3 cm.

11. A candle for producing a flow of oxygen comprising the solid material of any one of the preceding claims or at least one tablet according to any of claims 9-10.

12. The candle of claim 11, further comprising a starting part, in particular a start tablet having a composition comprising:
25-45% w/w self-sustaining decomposition additive, such as selected from Cu, Fe and a combination thereof, in particular 30-40% w/w additive, preferably 34-37% w/w additive;
46-71% w/w oxygen generating component, such as NaClO₃;
2-5% w/w inorganic binder, such as Na₂SiO₃;
2-4% w/w self-sustaining decomposition additive, such as MnO₂;
preferably wherein the starting tablet is provided at an end of one or more stacked tablets.

13. A method for producing oxygen of more than 99% purity, preferably more than 99.4% purity, more preferably more than 99.7% purity, and comprising less than 100 ppm of Cl₂ and CO respectively, more in particular less than 10 ppm respectively, more preferably less than 5 ppm respectively, said method comprising
providing a mixture according to any of claim 1-8, a fuel tablet according to any of claims 9-10, or a candle according to any of claims 11-12, and
increasing the temperature to above 200° C., and producing oxygen.

14. Method according to claim 13, producing a flow of at least 0.4 L/min/cm² flow directional cross section for at least 60 seconds and preferably a mass loss of better than 10% from theoretical mass loss, said fuel tablet has a flow directional cross section area of 1-20 cm², preferably 2-17 cm², and/or a height of 0.5-5 cm, such as 1-3 cm.

15. A start tablet having a composition comprising:
25-45% w/w self-sustaining decomposition additive, such as selected from Cu, Fe and a combination thereof, in particular 30-40% w/w selected from Cu, Fe and a combination thereof;
46-71% w/w oxygen generating component, such as NaClO₃, in particular 50-65% w/w NaClO₃;
2-5% w/w inorganic binder, such as Na₂SiO₃;
2-4% w/w self-sustaining decomposition additive, such as MnO₂; and preferably a water content below 0.5 wt %, in particular below 0.15 wt %.

16. The start tablet of claim 15, wherein said start tablet is produced from said chemical components as powders having a combined volume particle size distribution of mixture average of between 20 and 50 μm and a full width at half maximum (FWHM) of less than 20 μm at the lower particle seize range and 50 μm at the higher particle seize range and measured using laser scattering, said powders mixed and pressed into said at least one tablet, and with substantially no particles smaller than the manganese dioxide powder particles and substantially no particles larger than the sodium metasilicate powder particles.

17. A method for producing a fuel tablet for use in an oxygen-producing system, said method comprising:
providing a mixture of the chemical components comprising
1-25% w/w of a self-sustaining decomposition additive,
70-97% w/w of an oxygen generating component,
2-5% w/w of an inorganic binder,
from said chemical components as powders having a combined volume particle size distribution of mixture average of between 5 and 100 μm and a lower full width at half maximum (LFWHM) of less than 20 μm at the lower particle size range and a higher full width at half maximum (HFWHM) of less than 50 μm at the higher particle size range, measured using laser scattering;
producing granules from said mixture, said granules having a granule particle size of 1-4 mm sieve fraction, in particular 1-3 mm sieve fraction, and between 2 and 7% w/w water, preferably between 3 and 6 weight %;
pressing a tablet from said granules, and
drying said tablet to a water content of below 1% w/w based upon total weight, preferably below 0.5% w/w, more preferably below 0.2% w/w.

18. The method of claim 17, wherein particle in said powder are substantially smaller than MnO₂ particles and substantially no particle is larger than Na₂SiO₃ particles.

19. The method of any one of the preceding claims 17-18, wherein said volume particle size distribution of said mixture of powders has an average of between 20 and 50 μm and has a FWHM less than 20 μm at the lower particle size and less than 40 μm at the higher particle size when measured using laser scattering.

20. The method according to any one of the preceding claims, wherein said granules have a granule particle size of maximal 4 mm (sieve fraction), in particular 2 mm (sieve fraction).

21. The method according to any one of the preceding claims, wherein said start tablet is pressed at pressure of between 1.5 and 10 bar, in part around 1.7 bar.

22. A system for generating a flow of oxygen, comprising the mixture of any one of the preceding claims in a candle comprising at least 3 fuel tablets and one start tablet.

23. The system of claim 22, further comprising an ignition device providing 200-950° C. to said start tablet.

24. A kit-of-parts comprising at least one of a mixture according to any of claims 1-8, a tablet according to any of claims 9-10, a candle according to any of claims 11-12, and a start tablet according to claim 15.

25. The solid material for generating a flow of oxygen of any one of the preceding claims, in particular claims 1-8, wherein the self-sustaining decomposition additive comprises a fuel component and a catalyst component, wherein the catalyst component comprises 1-10% w/w, in particular 1-4% w/w of the solid material, and wherein:
the fuel component is selected from the group of copper (Cu), aluminium (Al), magnesium (Mg), zinc (Zn), molybdenum (Mo), manganese (Mn), cobalt (Co), nickel (Ni), iron (Fe), chrome (Cr), titanium, and combinations thereof;
the catalytic component is selected from the group of cobalt oxides (Co₂O₃ and Co₃O₄), copper oxide (CuO), iron oxide (Fe₂O₃), zinc oxide (ZnO), manganese oxide (MnO), manganese dioxide (MnO₂), manganese oxide complexes MnₓO_{y}, chrome (Cr), chrome oxides, titanium oxides, and combinations thereof.

26. The solid material of claim 25, wherein the fuel component comprises 4-6% w/w of Fe and 7-12% w/w Cu, in particular 4-5% w/w Fe and 10-11% w/w Cu, and the catalyst component comprises 3-4% w/w MnO₂,
wherein more in particular the solid material comprises:
78-80% w/w of the oxygen generating component selected from sodium perchlorate (NaClO4), sodium chlorate (NaClO3), potassium perchlorate (KClO4) and potassium chlorate (KClO3), more preferably from sodium chlorate (NaClO3), and
2-4% w/w selected from Na2SiO3, K2SiO3, and combinations thereof.
